(19) United States
(12) Patent Application Publication
(10) Pub. No.: US 2026/0049164 A1
(43) Pub. Date: Feb. 19, 2026

(54) METHOD FOR PREPARING RUBBERS

(71) Applicant: INEOS STYROLUTION GROUP GMBH, Frankfurt am Main (DE)

(72) Inventors: Wolfgang FISCHER, Heidelberg (DE); Attila NAGY, Ludwigshafen am Rhein (DE)

(21) Appl. No.: 19/103,852

(22) PCT Filed: Aug. 16, 2023
(86) PCT No.: PCT/EP2023/072546

§ 371 Date: Feb. 14, 2025

(30) Foreign Application Priority Data
Aug. 18, 2022 (EP) 22190944.3

(51) Int. Cl. C08F 6/24; C02F 1/00; C02F 1/52; C02F 101/32; C08F 6/00

(52) U.S. Cl. CPC C08F 6/24; C02F 1/001; C02F 1/5236; C08F 6/008; C02F 2001/007; C02F 2101/32

(57) ABSTRACT

The invention relates to a method for preparing rubbers from a dispersion (1) containing the rubber, said method comprising: (a) feeding the dispersion (1), that contains the rubber, and a precipitation solution (3) into a precipitation tank (5), an aqueous suspension (9) that contains rubber particles being produced; (b) optionally sintering the rubber particles contained in the aqueous suspension (9) that contains rubber particles to form larger particles; (c) mechanically dewatering the aqueous suspension (9) that contains rubber particles, rubber particles (33) that contain residual moisture and a liquid phase (35) that contains fine-particle rubber being obtained, the liquid phase (35) that contains fine-particle rubber being returned to the precipitation tank (5).

The present invention relates to a process for treatment of rubbers from a dispersion containing the rubber, wherein the dispersion containing the rubber and a precipitation solution are supplied to a precipitation vessel to produce an aqueous suspension containing rubber particles, the rubber particles present in the aqueous suspension containing rubber particles are optionally sintered to afford larger particles and the aqueous suspension containing rubber particles is mechanically dewatered to afford rubber particles containing residual moisture and a liquid phase containing finely divided rubber.

Particulate rubbers treatable with the process according to the invention are often used as impact modifiers in the production of thermoplastic polymers or other plastics, especially also in the production of styrene-based copolymers such as acrylonitrile-butadiene-styrene copolymers (ABS) or acrylonitrile-styrene-acrylate copolymers (ASA). These thermoplastic products may then be used with great versatility in molding compounds and molded parts.

The particulate rubbers, especially butyl acrylate graft rubbers or butadiene graft rubbers, are generally produced by an emulsion polymerization in an aqueous system and subsequently precipitated using a precipitation solution. The resulting particles are then typically dewatered, for example by filtration, sieving, decanting, pressing out the water or centrifugation, optionally washed with water during the dewatering or subsequently and then optionally freed of further water by thermal drying.

Processes for producing particulate rubbers as a component in the production of ASA or ABS moulding compounds are described for example in EP-A 0 734825, WO-A 2020/043690, WO-A 2015/000873 or WO-A 2015/004112. To maximize space-time yields the dispersions are generally produced with a solids content of 30% by weight or more.

The disadvantage of all known processes is that the water separated in the dewatering still contains rubber particles which are generally sent for disposal with the separated water.

In addition, finely divided rubber which is not retained in the dewatering due to the mesh size of sieves or pore size of filters passes into the wastewater and must be removed from the wastewater during treatment thereof and subsequently sent for disposal. The precipitation salt present in the separated water is also disposed of entirely via the wastewater. Likewise, precipitation of dispersions with a high solids content easily leads to blockages in the precipitation and/or sintering process parts.

It is accordingly an object of the present invention to provide a process for workup of rubbers from a dispersion containing the rubber which provides a better yield and in which the amount of the product and precipitation salt removed from the process with the water can be minimized while simultaneously minimizing the risk of blockages in the precipitation and/or sintering process parts.

This object is achieved by a process for treatment of rubbers from a dispersion containing the rubber comprising:
(a) supplying the dispersion containing the rubber and a precipitation solution to a precipitation vessel to obtain an aqueous suspension containing rubber particles,
(b) optionally sintering the rubber particles present in the aqueous suspension containing rubber particles to afford larger particles;
(c) mechanically dewatering the aqueous suspension containing rubber particles to obtain rubber particles containing residual moisture and a liquid phase containing finely divided rubber,
   wherein the liquid phase containing finely divided rubber is recycled to the precipitation vessel. It was found at the same time that reducing the solids content of dispersions having solids contents of more than 30% by weight to less than 25% by weight can markedly reduce the tendency to form blockages during precipitation and/or sintering.

As a result of the recycling of the liquid phase containing finely divided rubber to the precipitation vessel the finely divided rubber recycled with the liquid phase is typically subjected to thermal stress repeatedly, at least twice, since the precipitation in the precipitation vessel and/or the sintering in the sintering vessel are generally performed at elevated temperatures.

It has surprisingly been found that the repeated thermal stressing of the polymer particles recycled to the precipitation vessel with the liquid phase containing the finely divided rubber does not adversely affect the mechanical properties of products containing the rubber treated by the process according to the invention, with the result that the recycling makes it possible to increase the yield of rubber while maintaining product quality while at the same time minimizing the amount of the rubber removed from the process with the wastewater. The amount of wastewater and thus also the amount of precipitation salt required is likewise minimized while the precipitation and/or the sintering may at the same time be operated with a reduced solids content, thus reducing the risk of blockage in this process step.

The rubber treated by the process according to the invention may be a grafted rubber. Preference is given to a rubber comprising one or more grafted-on shells of other, generally non-elastomeric, polymers. To this end the single-or multi-stage elastomeric base stages are obtained by polymerization of one or more of the monomers butadiene, isoprene, chloroprene, styrene, alkyl styrene, C₁-to C₁₀-alkyl esters of acrylic acid or meth-acrylic acid and small amounts of other monomers, also including crosslinkable monomers, and the hard graft stages are polymerized from one or more of the monomers styrene, alkyl styrene, acrylonitrile and methyl methacrylate. It is also possible to produce the starting stage using a seed obtained on the basis of the monomers butadiene, isoprene, chloroprene, styrene, alkyl styrene, C₁-to C₁₀-alkyl esters of acrylic acid or meth-acrylic acid and small amounts of other monomers, also including crosslinkable monomers.

Preference is given to rubbers based on butadiene/styrene/acrylonitrile, n-butyl acrylate/styrene/acrylonitrile, butadiene/n-butyl acrylate/styrene/acrylonitrile, n-butyl acrylate/styrene/methyl methacrylate, butadiene/styrene/acrylonitrile/methyl methacrylate and butadiene/n-butyl acrylate/methyl methacrylate/styrene/acrylonitrile. Up to 10% by weight of polar monomers bearing functional groups or else crosslinking monomers may be incorporated in the seed and/or core and/or shell by polymerization.

Examples of the rubbers treated by the process according to the invention include polymers of conjugated dienes such as butadiene having an external graft shell, especially based on a vinylaromatic compound, for example SAN copolymers. The rubbers may also be graft rubbers based on crosslinked polymers of C₁-to C₁₀-alkyl esters of acrylic acid such as n-butyl acrylate or ethylhexyl acrylate grafted with polymers based on vinylaromatic compounds such as SAN copolymers.

The process is also suitable for graft rubbers which essentially contain a copolymer of conjugated dienes and C₁ to C₁₂ alkyl acrylates, for example a butadiene-n-butyl acrylate copolymer, and one or more graft stages composed of SAN copolymer, polystyrene or PMMA. Butadiene graft rubbers and butyl acrylate graft rubbers are particularly preferred.

The rubber is typically produced in an aqueous system, for example by emulsion polymerization as described for example in WO-A 2020/043690.

Emulsion polymerisation forms an aqueous dispersion with water as a continuous phase and rubber particles produced in the polymerisation as a disperse phase.

For treatment the dispersion is introduced into a precipitation vessel. To convey the dispersion from the emulsion polymerization it is preferable to employ a peristaltic pump if the dispersion storage tank does not allow a sufficient gradient for pump-free gravity-fed addition.

The dispersion supplied to the precipitation vessel preferably has a solids content in the range from 10% to 50% by weight, more preferably from 20% to 45% by weight and particularly preferably from 30% to 40% by weight. The solid present in the dispersion is the rubber present in particulate form.

In the precipitation vessel the dispersion is converted into an aqueous suspension containing rubber particles by addition of a precipitation salt solution preferably containing at least one salt and/or one acid.

In the context of the present invention a dispersion is to be understood as meaning a mixture of particles having a volume-average particle diameter Dv of 20 to 999 nm, preferably in the range from 50 to 800 nm, in a liquid phase. The volume-average particle diameter Dv (or the average particle diameter according to De Broucker), is an average parameter based on the unit volume of the particles. The volume-average particle diameter of the particles in the dispersion may be determined for example by light scattering (laser diffraction), for example with a Beckman Coulter instrument.

The suspension is to be understood as meaning a mixture of particles in a liquid phase whose particles are greater than the particles of the dispersion. To determine the particle size of the suspension it is possible to use, depending on the type of determination of the particle size and the size distribution, for example the D10 value, the D50 value or the D90 value, wherein the D10 value specifies the particle size up to which 10% by weight of particles are smaller, the D50 value accordingly specifies the particle size up to which 50% by weight of particles are smaller and the D90 value specifies the particle size up to which 90% by weight of particles are smaller. The particles in the suspension typically have a D10 value in the range from 50 to 400 μm, a D50 value in the range from 200 to 2000 μm and/or a D90 value in the range from 500 to 4000 μm. The particles in the suspension particularly preferably have a D10 value of 50 to 400 μm, a D50 value of 200 to 2000 μm and/or a D90 value of 500 to 4000 μm.

The particle size of the particles of the suspension is preferably determined by wet sieving which employs sieve towers comprising sieves of different mesh sizes. After sieving, the mass of the particles on the individual sieves is determined, thus making it possible to derive the D10 value, the D50 value and the D90 value.

The precipitation solution preferably contains a divalent salt or a trivalent salt and the precipitation solution especially contains at least one alkaline earth metal salt, preferably a magnesium salt and/or calcium salt, particularly preferably at least one magnesium salt.

The at least one alkaline earth metal salt is especially selected from alkaline earth metal halides, such as chlorides, alkaline earth metal sulfates, alkaline earth metal phosphates, such as orthophosphates or pyrophosphates, alkaline earth metal acetates and alkaline earth metal formates. The at least one alkaline earth metal salt is preferably selected from chlorides and sulfates.

Preferred alkaline earth metal salts are magnesium sulfate (such as kieserite (Mg[SO₄]·H₂O), pentahydrite (Mg[SO₄]·5H₂O), hexahydrite (Mg[SO₄]·6H₂O) and epsom salts (Mg[SO₄]·7H₂O)), magnesium chloride, calcium chloride, calcium formate, magnesium formate or mixtures thereof. Particular preference is given to the use of magnesium sulfate.

If the precipitation solution contains a trivalent salt, anhydrous aluminum sulfate or aluminum sulfate with water of crystallization are particularly preferred.

The amount of salt added depends on the amount of water present in the dispersion and is preferably in a range from 0.1% to 3% by weight, preferably in a range from 0.5% to 3% by weight and in particular in a range from 0.5% to 2% by weight of salt, in each case based on the amount of water in the dispersion.

The pH of the mixture of dispersion and precipitation solution obtained in step (a) is preferably in the range from 5 to 10, more preferably in the range from 6 to 9 and especially in the range from 8 to 9.

The pH may be adjusted for example by addition of buffer salts, acids and/or bases, for example using sulfuric acid, phosphoric acid, solutions of sodium hydroxide, potassium hydroxide, sodium salts and potassium salts of carbonates (for example sodium carbonate Na₂CO₃ and/or sodium hydrogencarbonate NaHCO₃ or mixtures thereof), sulfates or phosphates (for example tetrasodium pyrophosphate).

It is preferable to add for example at least one buffer salt from the group of sodium salts, especially selected from the group of sodium carbonates, sodium sulfates and sodium phosphates, preferably from the group of sodium carbonates Na₂CO₃ and sodium hydrogencarbonates NaHCO₃.

The buffer salts, acids and/or bases may already be added during production of the rubber in the emulsion polymerization or admixed in the precipitation vessel in step (a).

Addition is preferably carried out during production of the rubber in the emulsion polymerization.

To precipitate the rubber from the dispersion and obtain the aqueous suspension containing rubber particles the precipitation solution and the dispersion are typically mixed over a period in the range from 5 to 50 minutes, preferably 5 to 40 minutes.

The precipitation in step (a) may be carried out in a temperature range from 20° C. to 150° C., preferably from 40° C. to 100° C., particularly preferably from 45° C. to 99° C., likewise preferably from 60° C. to 95° C. It is preferable when the dispersion is mixed with the at least one precipitation solution at a temperature in the range from 30° C. to 95° C., preferably 40° C. to 95° C., particularly preferably 40° C. to 90° C.

To obtain larger particles the rubber particles present in the aqueous suspension containing rubber particles obtained in step (a) may be agglomerated to afford larger particles in a subsequent sintering step (b). To this end the aqueous suspension containing rubber particles obtained in step (a) is preferably conveyed to a sintering vessel in which the aqueous suspension containing rubber particles is maintained at a temperature in the range from 70° C. to 150° C., preferably in the range from 75° C. to 140° C. and particularly preferably in the range from 85° C. to 140° C. The aqueous suspension containing rubber particles is particularly maintained at this temperature for a period of 10 to 90 minutes, preferably 15 to 90 minutes, particularly preferably 15 to 80 minutes.

It is particularly preferable when the mixing of the dispersion and the precipitation solution in step (a) is carried out at a temperature in the range from 30° C. to 95° C. and preferably in the range from 40° C. to 90° C. and, if step (b) is performed, the sintering in step (b) is carried out for at least 5 minutes at a temperature in the range from 70° C. to 120° C., preferably 80° C. to 100° C.

The precipitation of the rubber particles in step (a) and the sintering in step (b) may be performed in different vessels or in the same vessel, wherein precipitation and sintering in the same vessel is possible especially when the process is in batchwise operation since, in this case, initial mixing of the dispersion with the precipitation solution at relatively low temperature is followed by sintering of the rubber particles at relatively high temperature. It is therefore preferable when a precipitation vessel is used for step (a) and a sintering vessel is used for step (b), wherein the sintering vessel and the precipitation vessel are two different vessels. To transport the aqueous suspension containing rubber particles the sintering vessel and the precipitation vessel are connected with a connecting conduit which accommodates a pump.

To obtain the most uniform possible size distribution of the resulting agglomerated particles during sintering it is advantageous when both the precipitation of the rubber particles in the precipitation vessel and also the sintering are performed continuously.

In order to keep the suspension containing rubber particles in motion and to prevent sedimentation of the rubber particles, especially also when supplying the suspension to a subsequent plant part is not possible for example due to an outage, the connecting conduit between the precipitation vessel and the sintering vessel is provided with a recirculation circuit in which the aqueous suspension containing the rubber particles is re-circulated in a loop.

For continuous operation it is further advantageous to make the sintering vessel larger than the precipitation vessel if the required residence time in the sintering vessel is greater than the residence time in the precipitation vessel.

After precipitation or, if step (b) is performed, after sintering the aqueous suspension containing rubber particles is dewatered to obtain rubber particles containing residual moisture and a liquid phase containing finely divided rubber.

The water content of the rubber particles containing residual moisture is preferably not more than 60% by weight, more preferably not more than 50% by weight and especially not more than 40% by weight, in each based on the total mass of the rubber particles containing residual moisture. Water content may especially be determined using suitable analytical instruments, for example drying and weighing apparatuses, wherein a sample is dried until a constant weight of the sample over a certain period is achieved. By way of example the water content of the rubber particles containing residual moisture may be determined in a Halogen Moisture Analyzer HR73 from Mettler Toledo at 180° C. until attainment of constant weight for 30 seconds.

The water content of the rubber particles containing residual moisture obtained in step (c) is in particular in the range from 10% to 50% by weight, preferably in the range from 20% to 45% by weight and especially in the range from 20% to 40% by weight, in each case based on the total mass of the rubber particles containing residual moisture.

Mechanical dewatering is typically effected by continuous or batchwise centrifugation and/or filtration. Mechanical dewatering is preferably achieved by continuous centrifugation. To this end the aqueous suspension containing rubber particles is centrifuged for example at a centripetal acceleration of 200·g to 2000·g, where acceleration due to gravity g=9.81 m/s², preferably at a centripetal acceleration of 500·g to 1300·g, over a period of 1 second to 5 minutes, preferably of 1 to 120 seconds.

To prevent sedimentation of the rubber particles, especially in case of failure of a continuously operating mechanical dewatering, it is advantageous here too when the connection between the sintering vessel and the continuously operating mechanical dewatering, especially at least one centrifuge or at least one filtration apparatus, is provided with a recirculation circuit in which the suspension containing the sintered rubber particles may be intermediately stored before it is supplied to the centrifuge and/or the filtration apparatus. If a discontinuously emptied batch centrifuge is employed a buffering vessel for collecting the suspension containing the rubber particles is necessary.

The rubber particles containing residual moisture may then be washed with water and/or a mixture of water and a polar, water-miscible solvent and subsequently dried as described for example in WO 2020/043690.

Since the liquid phase separated from the rubber particles containing residual moisture in the mechanical dewatering of the aqueous suspension containing rubber particles still contains finely divided rubber the liquid phase containing the finely divided rubber is recycled to the precipitation vessel according to the invention.

For buffering of variations in throughput in the individual process steps it is preferable when the liquid phase containing the finely divided rubber is initially collected in a recycled water vessel before it is returned to the precipitation vessel. This also makes it possible to control the amount of liquid phase containing finely divided rubber which is admixed with the dispersion in the precipitation vessel in order for example to establish a desired content of solid in the mixture of the dispersion from the emulsion polymerization supplied to the precipitation vessel and the liquid phase containing the finely divided rubber.

Since the amount of finely divided rubber in the liquid phase containing the finely divided rubber is only very low and generally not more than 2% by weight and especially in the range from 0.01% to 1% by weight in each case based on the total mass of the liquid phase containing the finely divided rubber, it is further preferable when the recycled water vessel is a settling vessel in which a high-rubber phase and a low-rubber phase are formed. The high-rubber phase may be the upper phase or the lower phase depending on the density of the rubber.

To prevent the liquid phase present in the recycled water vessel from being stirred up and intermixed by introduction of further liquid phase containing finely divided rubber as obtained in subsequent mechanical dewatering steps and also to prevent foaming in the recycled water vessel it is preferable when the liquid phase containing the finely divided rubber is introduced into the recycled water vessel via a dip pipe. Especially if the recycled water vessel is a settling vessel this can prevent the incipient high-rubber phase and low-rubber phase from being intermixed again.

The proportion of rubber in the high-rubber phase is high enough that the high-rubber phase from the recycled water vessel may be returned directly to the precipitation vessel. The content of rubber in the low-rubber phase is preferably not more than 0.5% by weight, more preferably in the range from 0.001% to 0.1% by weight and especially in the range from 0.001% to 0.07% by weight, in each case based on the total mass of the low-rubber phase.

Since the water of the recycled high-rubber phase contains not only the finely divided rubber but also dissolved salt and/or acid from the precipitation solution supplied to the precipitation vessel it is further preferable when the high-rubber phase returned directly to the precipitation vessel is mixed with the precipitation solution likewise introduced to the precipitation vessel before introduction to the precipitation vessel.

Mixing the precipitation solution with the returned high-rubber phase before introduction into the precipitation vessel has the further advantage that the formation of undesirably large rubber particles due to local high concentrations of the precipitation solution in the precipitation vessel and very rapid precipitation may be prevented.

The salt content may be determined for example via conductivity measurement or by titration, the acid content may be determined via pH determination and the flow rates may be determined in each case by providing a suitable flowmeter known to those skilled in the art in the conduits upstream of the mixing site. In order to adjust the desired concentration of salt and/or acid for the precipitation the mass flows of the supplied precipitation solution and the returned high-rubber phase are determined separately and the desired amount of precipitation solution is added using a ratio control means.

In order to also recover the rubber from the low-rubber phase and not to send it for disposal with the wastewater the low-rubber phase is preferably concentrated and then supplied to the precipitation vessel. The wastewater formed during the concentration is sent for disposal, wherein the wastewater amount preferably corresponds to the amount of water supplied with the dispersion and the precipitation solution minus the amount of water removed at other points of the process, especially the water still present in the rubber particles containing residual moisture. This makes it possible to achieve a continuous process without the amount of water in the process continually increasing due to recycled water.

Any process known to those skilled in the art for separating solids from a solids-containing liquid may be utilized to concentrate the rubber particles present in the low-rubber phase. It is very particularly preferable when the rubber particles are concentrated from the low-rubber phase with a filtration. Filtration of the low-rubber phase produces a high-rubber retentate and a substantially rubber-free filtrate and the high-rubber retentate is recycled to the precipitation vessel.

The filtration of the low-rubber phase may be operated continuously. In this case, pas-sage through the filtration apparatus concentrates the low-rubber phase by pressing liquid through the filter. This forms a high-rubber retentate that is recycled to the precipitation vessel and a substantially rubber-free filtrate that may be sent for disposal as wastewater. The rubber content in the retentate may be adjusted for example by adapting the volume flow through the filter, the pressure difference over the filter and/or the filter surface area. It is possible to employ only one filter or two or more filters, wherein the filters may be connected in parallel and/or in series.

However, alternatively and preferably the filtration is operated such that the rubber present in the low-rubber phase is deposited on the filter of the filtration apparatus as filter cake and the liquid is withdrawn from the filter as substantially rubber-free filtrate. In this case the resulting filter cake is discontinuously washed into the precipitation vessel with filtered recycled water.

Filters that may be utilized to concentrate the rubber from the low-rubber phase include for example edge-split filters. Suitable filter materials include for example edge-splits, wherein the split size of the filter is preferably in the range from 10 to 500 μm, more preferably in the range from 50 to 250 μm and especially preferably in the range from 75 to 200 μm.

The filtration typically results in deposition of solid on the filter to form a filter cake. Depending on the volume flow of the low-rubber phase passed through the filter apparatus at least a portion of the filter cake may be washed from the filter with the low-rubber phase in which the rubber accumulates during filtration and recycled to the precipitation vessel with the retentate.

If a filter cake which cannot be washed off with the retentate is formed it is preferable to wash the filter regularly. The time at which the filter is washed may be determined for example by the increase in the necessary pressure difference required to press the filtrate through the filter. Even if the filtration is performed such that the rubber from the low-rubber phase is separated so as to form a filter cake the accordingly resulting filter cake is regularly washed from the filter as described above and the washing liquid with the rubber present therein returned to the precipitation vessel.

If a filter is utilized which does not require application of positive pressure on the retentate side and/or negative pressure on the filtrate side the time at which washing of the filter becomes necessary may also be determined by means of the filtrate volume flow or the solids content in the retentate.

Washing of the filter may be achieved by passing a washing liquid through the filter from the filtrate side to the retentate side, thus washing the filter cake from the filter. It is alternatively also possible to supply the washing liquid to the filter instead of the low-rubber phase. Since the filter cake contains substantially rubber it is preferable when the washing liquid comprising the rubber from the filter cake present therein is introduced into the precipitation vessel. To allow the washing liquid comprising the rubber present therein to be introduced to the precipitation vessel it is preferable to employ a washing liquid containing only such components as are also present in the liquid in the precipitation vessel. It is therefore particularly preferable to employ water as the washing liquid.

The substantially rubber-free filtrate is removed from the process and preferably supplied to a wastewater treatment before the wastewater is discharged to the environment.

If the amount of liquid phase containing finely divided rubber that is supplied to the recycled water vessel from the mechanical dewatering is greater than the amounts of high-rubber phase and low-rubber phase withdrawn from the recycled water vessel, with the result that the fill level in the recycled water vessel can exceed a maximum fill level, the recycled water vessel preferably comprises an overflow by which a wastewater stream can exit the recycled water vessel.

If the rubber has a lower density than the liquid it floats in the recycled water vessel, with the result that the high-rubber phase is found in the upper region of the recycled water vessel. In this case the overflow is therefore preferably arranged in the lower region of the recycled water vessel in order ideally to withdraw only low-rubber phase in the case that the fill level in the recycled water vessel exceeds a maximum fill level. To allow the liquid to be discharged without providing an additional valve it is therefore preferable when the conduit forming the overflow initially runs upwards up to the height of the maximum fill level and there comprises a curvature of at least 90°so that the low-rubber phase can flow out via the overflow only upon achieving the maximum fill level on account of the hydrostatic pressure.

The rubber will correspondingly sink if it has a density higher than the liquid. In this case the high-rubber phase is at the bottom of the recycled water vessel and the low-rubber phase is at the top, so that when the overflow is arranged in the upper region of the recycled water vessel, preferably at the position of the maximum fill level, and low-rubber phase flows into the overflow when the fill level in the recycled water vessel becomes excessively high.

Especially when using the recycled water vessel in a swing plant which produces both rubber having a lower density and rubber having a higher density than the liquid it is preferable to arrange an overflow at the top of the recycled water vessel, preferably at the position of the maximum fill level, and an overflow at the bottom of the recycled water vessel, wherein in the case of a rubber having a density lower than the density of the liquid, the overflow at the top of the recycled water vessel is closed and in the case of a rubber having a density higher than the density of the liquid, the overflow at the bottom of the recycled water vessel is closed. It is further preferable when the overflow at the bottom is connected via a conduit with the overflow at the top of the recycled water vessel, wherein the conduit opens into overflow downstream of a shutoff device and the opening of the conduit into the overflow is preferably at the same height as the connection of the overflow to the recycled water vessel.

Once the fill level in the recycled water vessel exceeds the maximum fill level, high-rubber phase flows into the overflow. To prevent the high-rubber phase, which then flows into the overflow, from passing to a wastewater disposal, thus resulting in loss of the rubber in the high-rubber phase, it is in this case preferable to provide a recycle conduit which branches off from the overflow and opens into the conduit through which the low-rubber phase flows to the concentration, especially the filtration. This makes it possible to prevent the liquid withdrawn from the overflow, which still contains rubber, from being sent for disposal and thus the rubber present therein from being removed from the process as waste.

The pump used to convey the liquid phase containing the sintered rubber particles or, if the separate sintering step was not performed, suspension containing the rubber particles obtained in step (a) to the mechanical dewatering is preferably in the form of a centrifugal pump configured as a vortex pump. The pump employed to convey the low-rubber phase to the filtration is preferably an eccentric screw pump.

The use of a centrifugal pump configured as a vortex pump or an eccentric screw pump allows transport of the liquid phase containing rubber particles without any possibility of the pump being blocked by the rubber particles present in the liquid phase since such a pump comprises a sufficiently large flow channel that is traversable by the liquid without contacting the impeller of the pump.

In order to prevent wear or blockage of the eccentric screw pump through swelling of the plastic due to any residual monomers still present and thus enable uniform conveying of the liquid phase containing the rubber particles it is further preferable when the stator and/or the rotor of the eccentric screw pump is/are manufactured from chlorosulfonated polyethylene rubber (CMS), for example obtainable as Hypalon® from DuPont Performance Elastomers.

Since the rubber particles undergo further agglomeration and thus increase in size with increasing residence time it is further preferable to be able to control the particle size of the rubber particles precipitated in step (a) and/or the rubber particles sintered in step (b). To this end it is possible for example to employ a pump comprising a cutting device for particle comminution and/or to connect a particle comminution means upstream of the pump.

Suitable particle comminution means include for example wet milling apparatuses which are traversed by the liquid phase containing the rubber particles and which typically contain cutting devices, wherein the cutting devices may be fixedly comprised in the particle comminution means or may be configured as a rotor and stator. Suitable particle comminution means include for example Siefer Trigonal® machines.

Pumps that contain rotor-stator toothed mixing elements for particle comminution are available, for example, under the designation Supraton® inline homogenisers from BWS Technologie GmbH.

Exemplary embodiments of the invention are shown in the drawing and are elucidated in more detail in the description that follows and the claims.

In the figures:

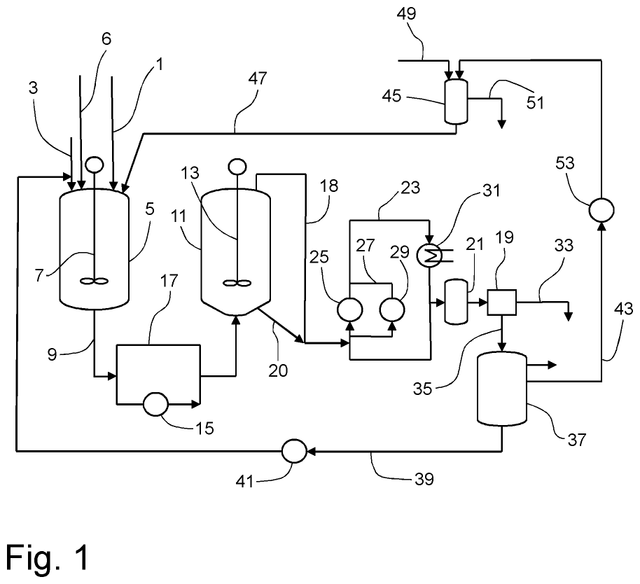

FIG. 1 Shows a Flow Diagram of the Process According to the Invention;

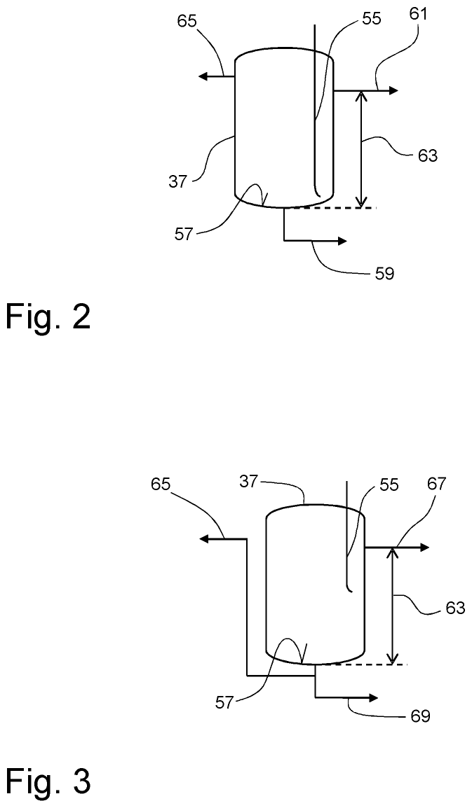

FIG. 2 is a schematic representation of a recycled water vessel for rubber particles having a density higher than the density of the liquid,

FIG. 3 is a schematic representation of a recycled water vessel for rubber particles having a density lower than the density of the liquid,

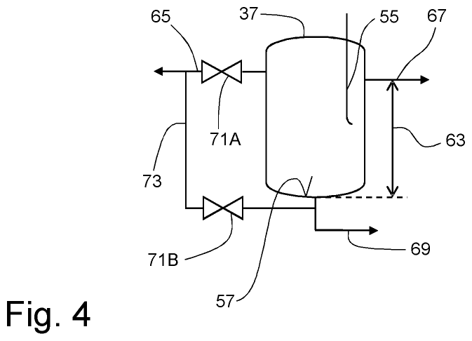

FIG. 4 is a schematic representation of a recycled water vessel for a swing plant in which rubber particles having a density lower than the density of the liquid and rubber particles having a density higher than the density of the liquid are alternately produced.

FIG. 1 Shows a Flow Diagram of the Process According to the Invention;

For treatment of rubbers from a dispersion containing the rubbers the rubber-containing dispersion 1 which derives from an emulsion polymerization for example is introduced into a precipitation vessel 5 together with a precipitation solution 3. The dispersion 1 is preferably conveyed to the precipitation vessel 5 solely by gravity. Should conveying by gravity be impossible, especially if the dispersion storage tank in which the dispersion is intermediately stored is too low, the dispersion 1 is preferably conveyed to the precipitation vessel 5 with a peristaltic pump. To adjust the concentration in the precipitation vessel 5 water may additionally be supplied via a conduit 6 either directly into the precipitation vessel 5 or alternatively into the conduit through which the precipitation solution 3 is introduced.

In the precipitation vessel the dispersion 1 containing the rubber and the precipitation solution 3 are intermixed with a mixing apparatus 7, for example a stirrer, to form an aqueous suspension containing rubber particles. The aqueous suspension 9 containing rubber particles is removed from the precipitation vessel and supplied to an optional sintering vessel 11 in which the rubber particles agglomerate to afford larger particles. To prevent settling of the rubber particles the suspension containing rubber particles present in the sintering vessel 11 is likewise intermixed using a mixing apparatus 13, for example a stirrer.

To convey the aqueous suspension 9 containing the rubber particles from the precipitation vessel 5 to the sintering vessel 11 a first pump 15 is accommodated in the conduit connecting the precipitation vessel 5 and the settling vessel 11. It is preferable when the first pump 15 is part of a recirculation circuit 17 in which especially in case of failure of the withdrawal from the sintering vessel 11, for example in case of failure of plant parts downstream of the sintering vessel, the suspension 9 containing rubber particles is kept in motion, thus preventing sedimentation of the particles. The first pump 15 is preferably a centrifugal pump configured as a vortex pump.

The suspension 18 now containing larger rubber particles is supplied from the sintering vessel 11 to a mechanical dewatering 19. The mechanical dewatering 19 may be effected for example by centrifugation or filtering, wherein centrifugation is preferred. To effect draining of the sintering vessel 11 a draining conduit 20 is preferably provided at the bottom of the sintering vessel. In normal operation the draining conduit 20 is closed and the aqueous suspension 18 containing larger rubber particles produced in the sintering vessel is withdrawn via the withdrawal conduit at the top of the sintering vessel 11.

Especially in the case of a batchwise mechanical dewatering 19 it is necessary for the aqueous suspension containing rubber particles supplied to the mechanical dewatering 19 to be intermediately stored. A buffering vessel 21 in which the aqueous suspension 18 containing rubber particles is intermediately stored may for example be provided to this end. To prevent rubber particles sedimenting out of the suspension it is preferable when the buffer vessel 21 comprises a mixing apparatus, for example a stirrer, with which the suspension may be stirred.

Alternatively or in addition it is further preferable to provide, as shown here, a second recirculation circuit 23 in which the aqueous suspension containing rubber particles may be recirculated. The aqueous suspension containing rubber particles is intermixed in the second recirculation circuit 23 in order to prevent precipitation of the rubber particles. The second recirculation circuit 23 is advantageous especially when the mechanical dewatering is performed continuously.

If the mechanical dewatering 19 is operated continuously it is sufficient to provide the second recirculation circuit 23, though the buffering vessel 21 may also alternatively or in addition be connected upstream of the mechanical dewatering 19.

If the mechanical dewatering 19 is operated batchwise the buffering vessel 21 is necessary to intermediately store the suspension before the latter is supplied to the mechanical dewatering 19. However, it is possible here too, as shown in FIG. 1, to connect the buffering vessel 21 upstream of the second recirculation circuit 23.

Both for the transport of the aqueous suspension containing rubber particles from the sintering vessel 11 into the mechanical dewatering 19 and for the recirculation in the second recirculation circuit 23 a second pump 25 is accommodated in the second recirculation circuit 23. It is further preferable to provide a bypass 27 which makes it possible to circumvent the second pump 25, wherein a third pump 29 is accommodated in the bypass 27.

Alternatively to the embodiment shown here, the second pump 25 and the third pump 29 may also be connected in series. This is advantageous especially when the third pump 29 cannot build up a sufficiently high pressure relative to the second pump 25, since in this case a circular flow from the pressure side to the suction side would be established. It is preferable when the second pump 25 and the third pump 29 are each a centrifugal pump configured as a vortex pump similarly to the first pump 15.

Since the particles can further agglomerate in the second recirculation circuit 23 it is further preferable when the second pump 25 and/or the third pump 29 are provided with a cutting device for particle comminution. Use of the cutting device allows the particle size of the rubber particles to be adjusted to a desired size and particles attaining an undesired size due to agglomeration are comminuted. Especially when the suspension 18 containing rubber particles is conveyed directly into the mechanical dewatering 19 it is preferable when the second pump 25 and the third pump 29 are connected in series, wherein in this case the second pump 25 preferably does not contain a cutting device and establishes the necessary pressure and the third pump 29 having a cutting device is connected downstream of the second pump. If a buffering vessel 21 is present no significant pressurization is necessary and the second pump 25 and the third pump 20 may run in parallel.

Alternatively or in addition to a pump having a cutting device the second recirculation circuit 23 may also accommodate a particle comminutor which prevents formation of excessively large rubber particles. The particle comminutor is preferably a wet grinding apparatus.

The sintering of the rubber particles in the sintering vessel 11 is generally carried out at a temperature above the temperature at which the mechanical dewatering 19 is performed. It is therefore preferable to provide a heat exchanger 31 in the connection conduit from the sintering vessel 11 to the mechanical dewatering 19 to cool the aqueous suspension containing rubber particles.

If a second circulation circuit 23 is provided between the sintering vessel 11 and the mechanical dewatering 19 the heat exchanger 31 is preferably at a position in the second recirculation circuit 23 through which the aqueous suspension containing rubber particles flows even when said suspension is introduced directly from the sintering vessel 11 into the mechanical dewatering 19 and not recirculated in the second recirculation circuit 23. When using a buffering vessel 21 it is alternatively also possible to effect temperature control of the buffering vessel 21 with a cooling, for example via a double jacket or cooling tubes running inside the buffer vessel.

In the mechanical dewatering the rubber particles from the aqueous suspension containing rubber particles are separated, wherein rubber particles 33 containing residual moisture and a liquid phase 35 containing finely divided rubber are obtained. The rubber particles 33 containing residual moisture are withdrawn as a raw product from the workup process and supplied to an extruder for producing ABS or ASA for example.

The liquid phase 35 containing finely divided rubber is introduced into a recycled water vessel 37. The recycled water vessel 37 is preferably a setting vessel in which the finely divided rubber from the liquid phase containing the finely divided rubber accumulates, thus forming a high-rubber phase and a low-rubber phase.

The proportion of rubber in the high-rubber phase 39 is preferably high enough that the high-rubber phase from may be directly withdrawn from the recycled water vessel 37 and recycled into the precipitation 5.

In order to pass the high-rubber phase 39 from the recycled water vessel 37 into the precipitation vessel 5 a pump 41 may be accommodated in the connection conduit from the recycled water vessel 39 to the precipitation vessel 5. However, it is preferable when the recycled water vessel 37 is positioned higher than the precipitation vessel 5 so that the high-rubber phase 39 can flow into the precipitation vessel 5 purely under gravity, thus obviating the need for pump 41.

It is further preferable when the recycled high-rubber phase 39 is mixed with the precipitation solution 3 before introduction into the precipitation vessel 5.

In order also to obtain the rubber present in the low-rubber phase 43 as product and not to send it for disposal from the process with the wastewater the low-rubber phase 43 from the recycled water vessel 37 is supplied to a filtration 45. The filtration 45 concentrates the rubber from the low-rubber phase, thus forming a high-rubber retentate 47 that is introduced into the precipitation vessel 5.

If the filtration 45 is performed such that a filter cake is formed on the filter in the filtration apparatus, said cake is preferably regularly washed off and the washing solution with the rubber present therein introduced into the precipitation vessel 5 as high-rubber retentate 47. In order not to introduce any undesired components into the precipitation vessel 5 the backwashing is preferably effected with water, especially with demineralized water 49. It is alternatively possible to also employ filtrate 51 for backwashing.

The pore size of the filter used for the filtration 45 is preferably selected such that substantially all of the finely divided rubber present in the low-rubber phase is separated so as to form a substantially rubber-free filtrate 51 which is discharged as wastewater and supplied to a wastewater treatment and may then be sent for disposal.

A fourth pump 53 is preferably used to convey the low-rubber phase 43 to the filtration 45. It is possible here to employ any pump capable of conveying a liquid phase containing only a low solids content.

Suitable pumps include for example centrifugal pumps or eccentric screw pumps. When using an eccentric screw pump, it is particularly preferable when the stator and/or the rotor of the eccentric screw pump are manufactured from chlorosulfonated polyethylene rubber (CMS).

FIG. 2 shows a recycled water vessel 37 configured as a settling vessel in a first embodiment.

The liquid phase 35 containing the finely divided rubber is supplied to the recycled water vessel 37 via a dip pipe 55. Supplying the liquid phase 35 containing the finely divided rubber via the dip pipe 55 prevents the upper region of the recycled water vessel 37 comprising a rubber-depleted phase from being enriched with rubber from the liquid phase 35 containing the finely divided rubber. At the same time the inflow of the liquid phase 35 containing the finely divided rubber into the bottom region ensures that the rubber that is sedimenting does not form deposits in the bottom region of the recycled water vessel 37. In this way the recycled water vessel 37 may be employed as a settling vessel even if liquid phase containing finely divided rubber is introduced into the recycled water vessel 37 continuously or, in the case of batchwise mechanical dewatering, at respective regular intervals.

The rubber present in the liquid phase containing finely divided rubber accumulates in the recycled water vessel 37 configured as a settling vessel, thus forming a high-rubber phase and a low-rubber phase. If the rubber has a higher density than the liquid of the liquid phase containing finely divided rubber, the rubber sinks with the result that the high-rubber phase is at the bottom and the low-rubber phase is at the top. The rubber accordingly floats when the density of the rubber is lower than the density of the liquid of the liquid phase containing finely divided rubber, with the result that in this case the high-rubber phase is at the top and the low-rubber phase is at the bottom.

In the embodiment shown in FIG. 2 the recycled water vessel is particularly preferably employed when the rubber has a density higher than the density of the liquid. In this case the dip pipe 55 preferably terminates in proximity to the bottom 57 of the recycled water vessel 37, with the result that the newly supplied liquid phase containing finely divided rubber is supplied in the lower region of the high-rubber phase. This achieves a mixing of the high-rubber phase with the newly supplied liquid phase containing finely divided rubber in the proximity of the bottom 57 of the recycled water vessel 37, thus minimizing the amount of rubber which sediments and can form a covering on the bottom 57 of the recycled water vessel 37.

The high-rubber phase which is formed in the lower region of the recycled water vessel 37 is preferably withdrawn via an outflow 59 at the bottom 57 of the recycled water vessel and supplied to the precipitation vessel 5.

The low-rubber phase forms the upper phase in the precipitation vessel and is preferably withdrawn via an outflow 61 in the upper region of the recycled water vessel 37 and supplied to the filter 45, optionally via a pump 53 . It is particularly preferable when the outflow 61 for the low-rubber phase is arranged at a height corresponding to a desired maximum fill height 63.

An overflow 65 is provided to prevent overfilling of the recycled water vessel 37 especially when the amount of liquid phase containing finely divided rubber supplied to the recycled water vessel 37 is greater than the amount of high-rubber phase and low-rubber phase withdrawn from the recycled water vessel via the outflows 59 and 61. Since the low-rubber phase is in the upper region of the recycled water vessel 37 withdrawal via the overflow 65 withdraws only a very small amount of rubber from the recycled water vessel 37, thus ensuring a very low loss of product. The low-rubber liquid discharged via the overflow 65 is then typically supplied to a wastewater treatment so that the wastewater may be discharged to the environment after the treatment.

FIG. 3 shows a recycled water vessel 37 in a second embodiment as is preferably employed when the rubber has a density lower than the density of the liquid of the liquid phase containing the finely divided rubber, with the result that the rubber floats in the recycled water vessel and the high-rubber phase is formed at the top and the low-rubber phase is formed at the bottom.

In a departure from the recycled water vessel shown in FIG. 2, in the case of a recycled water vessel employed in a process where the high-rubber phase is formed at the top of the recycled water vessel 37 the dip pipe 55 terminates already in the middle region of the recycled water vessel so that the rubber supplied from the liquid phase containing finely divided rubber introduced via the dip pipe 55 ascends, with the result that the high-rubber phase forms above the opening of the dip pipe 55 into the recycled water vessel 37 and the low-rubber phase forms below the opening of the dip pipe 55.

Accordingly the high-rubber phase is withdrawn via an outflow 67 in the upper region of the recycled water vessel 37, wherein here too the outflow 67 is preferably arranged at the position of the desired maximum fill height 63. The high-rubber phase in the region of the phase interface, where in the case of ascending rubber the greatest rubber content is found, is hereby withdrawn from the recycled water vessel 37. Accordingly, the proportion of rubber in the low-rubber phase is lowest at the bottom 57 of the recycled water vessel 37 and so the low-rubber phase is withdrawn via an outflow 69 at the bottom 57 of the recycled water vessel 37.

Also in the embodiment shown in FIG. 3 the recycled water vessel 37 comprises an overflow 65 to prevent overfilling of the recycled water vessel 37. Since in the case of a light rubber the low-rubber phase is in the lower region of the recycled water vessel 37 the overflow 65 branches off from the outflow 69 at the bottom 57 of the recycled water vessel 37 and preferably runs upwards preferably outside the recycled water vessel 37 up to a height of the maximum fill level in the recycled water vessel. At the height of the maximum fill level the overflow 65 has a curvature of at least 90° so that the liquid can flow horizontally or downwards again after the curvature. The curvature represents the highest point of the overflow. This allows a low-rubber phase to exit the recycled water vessel 37 once the maximum fill level has been attained without any need for an additional shutoff device.

FIG. 4 shows a recycled water vessel 37 employable in a swing plant which alternately produces a rubber having a density lower than the density of the liquid of the liquid phase containing the finely divided rubber and rubber having a density higher than the density of the liquid of the liquid phase containing the finely divided rubber.

To avoid the need to use two different recycled water vessels in a swing plant depending on the density of the rubber produced, the recycled water vessel 37 employable in a swing plant comprises, in a departure from the embodiments shown in FIGS. 2 and 3, an overflow 65 which branches off at the position of the maximum fill level and which may be closed with a first shutoff device 71A and a conduit 73 which branches off from the outflow 69 at the bottom 57 of the recycled water vessel, which may be closed with a second shutoff device 71B and which opens into the overflow 65 downstream of the first shutoff device 71A at the same height at which the overflow 65 also branches off from the recycled water vessel 37. The shutoff devices 71A, 71B may independently of one another be a valve, a cock or a slider for example.

When a rubber is produced with a density higher than the density of the liquid of the liquid phase containing the finely divided rubber the first shutoff device 71A is opened and the second shutoff device 71B is closed. In this way when exceeding the maximum liquid level the low-rubber phase may exit the recycled water vessel 37 via the overflow 65. Since the high-rubber phase collects in the lower region of the recycled water vessel 37 the high-rubber phase is withdrawn from the recycled water vessel 37 via the outflow 69. The low-rubber phase may be withdrawn from the recycled water vessel 37 via the outflow 67.

Correspondingly, when using a rubber having a density less than the density of the liquid of the liquid phase containing the finely divided rubber the first shutoff device 71A is closed and the second shutoff device 71B is opened. In this case exceedance of the maximum fill height causes the low-rubber phase to run into the overflow 65 via the conduit 73. The high-rubber phase is withdrawn via the outflow 67 in the upper region of the recycled water vessel 37 and the low-rubber phase via the outflow 69.

Since depending on the density of the rubber produced the high-rubber phase is withdrawn either via the outflow 67 in the upper region of the recycled water vessel 37 or via the outflow 69 at the bottom 57 of the recycled water vessel 37 and the low-rubber phase correspondingly via the other outflow 69, 67, in each case the outflow 67, 69 by which the high-rubber phase is withdrawn is connected to the plant such that the high-rubber phase is passed into the precipitation vessel 5 and the outflow 67, 69 by which the low-rubber phase is withdrawn is connected to the filtration 45. This may be done for example using 3/2-way valves where the inlet is connected to the outflow 67, 69, one of the outlets is connected to a conduit to the precipitation vessel 5 and the other outlet is connected to a conduit to the filtration 45. Alternatively, the respective conduit to the precipitation vessel 5 or to the filtration 45 may also be connected to the corresponding outflow 67, 69. This is achievable for example with a hose which is connected to the respective outflow 67, 69 via a coupling.

### EXAMPLES

All examples and comparative examples employed an aqueous butyl acrylate graft rubber-containing dispersion (referred to as dispersion below). The butyl acrylate graft rubber in the dispersion had an average particle size of 95 nm and the proportion of graft rubber in the dispersion was 35% by weight.

All examples and comparative examples were performed in a workup plant as shown in FIG. 1 but without the buffer vessel 21 and with a recycled water vessel 37 as shown in FIG. 2.

The temperature in the precipitation vessel 5 was maintained at 60° C., wherein adjustment of the temperature was via direct supply of steam. From the precipitation vessel the obtained suspension was conveyed via the recirculation circuit 17 into the sintering vessel 11, wherein a temperature of 92° C. was maintained in the sintering vessel 11. The pump 15 in the recirculation circuit 17 was operated at a conveying rate of 11 m³/h. The second recirculation circuit 23 supplied the suspension obtained in the sintering vessel 11 to a continuously operated pusher centrifuge for mechanical dewatering 19. The flow rate in the recirculation circuit 23 was 85 m³/h. The split size of the filter in the continuously operated pusher centrifuge 19 and in the filter 45 was 100 μm in each case.

### Comparative Example 1

1.4 m³/h of the dispersion, 160 kg/h of a 14 % magnesium sulfate solution and 1.9 m³/h of demineralized water were introduced into the precipitation vessel. Neither the retentate obtained in filter 45 nor the high-rubber phase 39 obtained in the recycled water vessel were recycled to the precipitation vessel.

2.8 m³/h of rubber-containing phase exited the recycled water vessel and said phase was directly discharged as wastewater. The loss of rubber via the wastewater was 2.8 kg/h. In addition, 22 kg/h magnesium sulfate were discharged via the wastewater.

### Comparative Example 2

To reduce the losses via the wastewater the concentration in the precipitation vessel was increased by reducing the amount of demineralized water added. In comparative example 2 as well, neither the retentate obtained in filter 45 nor the high-rubber phase obtained in the recycled water vessel were recycled to the precipitation vessel. 1.4 m³/h of the dispersion, 160 kg/h of a 14 % magnesium sulfate solution and 0.9 m³/h of demineralized water were introduced into the precipitation vessel.

Now only 1.5 m3/h of liquid exited the recycled water vessel as wastewater. The loss of rubber via the wastewater was 1.5 kg/h and 12 kg/h of magnesium sulfate were discharged via the waste water.

### Example 1

In a departure from the comparative examples both the high-rubber phase 39 and the retentate 47 obtained in the filter 45 were recycled into the precipitation vessel.

For this example too, 1.4 m3/h of the dispersion were introduced into the precipitation vessel. The amount of supplied 14% magnesium sulfate solution was 51.4 kg/h. 1.9 m3/h of high-rubber phase 39 were recycled from the recycled water vessel to the precipitation vessel and the amount of recycled retentate 47 was 50 kg/h, wherein this was discontinuously introduced into the precipitation vessel.

The amount of filtrate 51 extracted from the filter 45 as wastewater was 0.7 m³/h. A loss of rubber was not detectable and the amount of magnesium sulfate discharged from the process via the filtrate was 5.5 kg/h.

It has thus been found that the process according to the invention makes it possible to maximize the yield of rubber since no rubber is withdrawn from the process with the wastewater and also to minimize the amount of magnesium sulfate removed from the process with the wastewater.

The process provided is thus also improved from an environmental standpoint.

1-15. (canceled)

16. A process for treatment of rubbers from a dispersion containing the rubber, the process comprising:
(a) supplying the dispersion containing the rubber and a precipitation solution to a precipitation vessel to obtain an aqueous suspension containing rubber particles;
(b) optionally sintering the rubber particles present in the aqueous suspension containing rubber particles to afford larger particles;
(c) mechanically dewatering the aqueous suspension containing rubber particles to obtain rubber particles containing residual moisture and a liquid phase containing finely divided rubber;
(d) collecting the liquid phase containing finely divided rubber in a recycled water vessel; and
(e) recycling the liquid phase containing finely divided rubber to the precipitation vessel.

17. The process of claim 16, wherein the liquid phase containing finely divided rubber is introduced into the recycled water vessel via a dip pipe.

18. The process of claim 16,
wherein the recycled water vessel is a settling vessel, and
wherein the process further comprises forming a high-rubber phase and a low-rubber phase in the settling vessel.

19. The process of claim 18, wherein the process further comprises recycling the high-rubber phase directly to the precipitation vessel.

20. The process of claim 18, wherein the process further comprises mixing the high-rubber phase with the precipitation solution before introduction into the precipitation vessel.

21. The process of claim 18, wherein the process further comprises:
concentrating the low-rubber phase; and
recycling the concentrated low-rubber phase to the precipitation vessel.

22. The process of claim 21,
wherein the low-rubber phase is concentrated by filtration to obtain a high-rubber retentate and a substantially rubber-free filtrate, and
wherein the high-rubber retentate is recycled to the precipitation vessel.

23. The process of claim 22, wherein the process further comprises:
collecting the high-rubber retentate in a filter as a filter cake, and
passing the high-rubber retentate in the filter as the filter cake into the precipitation vessel with a washing liquid.

24. The process of claim 16, wherein a wastewater stream can exit the recycled water vessel via an overflow.

25. The process of claim 16, wherein the process further comprises conveying the aqueous suspension containing rubber particles from step (a) or the suspension containing larger rubber particles from step (b) using a centrifugal pump configured as a vortex pump.

26. The process of claim 18, wherein the process further comprises conveying the low-rubber phase using an eccentric screw pump.

27. The process of claim 26,
wherein the eccentric screw pump comprises a stator and/or a rotor, and
wherein the stator and/or the rotor are manufactured from chlorosulfonated polyethylene rubber.

28. The process of claim 25,
wherein the centrifugal pump configured as a vortex pump comprises cutting devices for particle comminution, and/or
wherein the centrifugal pump configured as a vortex pump has a particle comminution means arranged upstream of it.

29. The process of claim 16, wherein the rubber is a butyl acrylate graft rubber or a butadiene graft rubber.

30. The process of claim 26, wherein the eccentric screw pump has a particle comminution means arranged upstream of it.
